(19) United States
(12) Patent Application Publication
(10) Pub. No.: US 2010/0120608 A1
(43) Pub. Date: May 13, 2010

(54) Reactive metal and catalyst amalgam and method for improving the combustibility of fuel oils

(76) Inventors: James W. Haskew, Joplin, MO (US); Thomas Matthew Bair, Colorado Springs, CO (US)

Correspondence Address: Randal D. Homburg, P.O. Box 10470, Midwest City, OK, 73140-1470, US

(21) Appl. No.: 12/657,185

(22) Filed: Jan. 16, 2010

Related U.S. Application Data
(63) Continuation-in-part of application No. 11/445,590, filed on Jun. 2, 2006.

(51) Int. Cl. B01J 27/13; B01J 23/42

(52) U.S. Cl. 502/230; 502/334

(57) ABSTRACT

A combination of metal catalysts are independently introduced to a fuel oil to enhance and improve the combustibility of the fuel oil and to adjust in real time the ratio of the metal catalyst mixture to the quality and/or quantity of the fuel oil. This combination of ionic metal catalysts may also be utilized to improve a low grade fuel oil to a higher grade fuel source while reducing the pollutants and minimizing the fuel related damage potential to the engine. The primary combination of metals includes Platinum, Indium, Rhodium, Aluminum and Rhenium in an adjustable ratio, with the ratio being variable depending on the fuel source and quantity. Chemicals and catalysts selected are utilized as molecular ions whose decomposition results in the form most effective to combustion.

### CROSS REFERENCE TO RELATED APPLICATIONS

This is a Continuation-in-Part Application of U.S. patent application Ser. No. 11/445,590, filed by the same inventors on Jun. 2, 2006, currently pending.

### I. BACKGROUND OF THE INVENTION

1. Field of Invention

A combination of metal catalysts are independently introduced to a fuel oil to enhance and improve the combustibility of the fuel oil and to adjust in real time the ratio of the metal catalyst mixture to the quality of the fuel oil. This combination of ionic metal catalysts may also be utilized to improve a low grade fuel oil to a higher grade fuel source while reducing the pollutants and minimizing the fuel related damage potential to the engine. The combination of metal catalysts includes Platinum, Indium, Rhodium, Aluminum and Rhenium in an adjustable ratio, with the ratio being variable depending on the fuel source. It is also contemplated within the scope of the disclosure that process of combustion related to this method and catalyst have not been fully researched and applied, and therefore it is unknown at this time what other chemicals, catalysts and/or metals may further enhance the effectiveness of this method and catalyst which could allow for other catalysts or chemicals to be injected at various stages of the combustion process.

2. Description of Prior Art

The following United States patents were discovered and are disclosed within this application for utility patent. Two patents disclosed herein are issued to James W. Haskew, one of the inventors in the present invention.

In U.S. Pat. No. 6,776,606 to Haskew, a catalyst compound of Platinum, Rhodium and Rhenium an other metallic compounds are introduced into an already combustible fuel to enhance the combustion of these combustible fuels. A method is also claimed in that patent. In U.S. Pat. No. 6,786,714 to Haskew, the generation of a sparging gas containing a catalyst mixture with subsequent delivery to a flame zone is disclosed, along with a method for the liquid catalyst.

Two other patents, U.S. Pat. No. 5,085,841 to Robinson and U.S. Pat. No. 6,419,477 to Robinson, also contain some prior art elements with reference to a combination of platinum, rhodium and rhenium in the first issued patent and the addition of platinum, rhodium, rhenium, molybdenum, aluminum and ruthenium to reduce NOx in hydrocarbon fuels and enhancing combustion per kilogram of fuel. The introduction of the metallic compound and air mixture occurs within the flame zone in the combustion chamber. A greater distinction between Robinson '477 and the present catalyst mixture and its applicability to heavy fuel oil combustibility is discussed below.

None of the prior art patents mention the conversion of a non-combustible hydrocarbons or bunker fuels to a combustible fuel source, nor do they include the addition of indium. Several articles pertain to bunker fuels, including those disclosed at www.bunkerworld.com including articles on bunker fuels grades, true worth indexes for bunker fuels, viscosity, bunker fuel quality, and other articles pertaining to problems associated with the use of bunker fuels for combustion engines.

### II. SUMMARY OF THE INVENTION

Fuel oils come in different grades, including #2 and #4 home heating oils, heating oil #6, bunker fuel #6 and bunker c. Bunker c fuels are most generally defined as crude oil or the byproduct left over after the refining process to distill the useable fuels from the crude oils. Most often the bunker fuels contain the very dark asphaltenes, waxes and very large molecular hydrocarbons. Prior to contemplation for use, most refiners will dilute the lower grade bunker fuels to meet various sales specification for trace metals, sulfur and/or viscosity. At ambient temperatures, bunker fuels are often solids, which require heating prior to being useable as a low grade liquid fuel source. In the past, bunker fuels require blending with higher grade liquid fuels to have any useful purpose.

Heavy fuel oils are generally used in engines adapted for their use with the low grade bunker fuels most often used in extremely large engines most often associate with the marine industry, railroad engines or large stationary engines used for power generation. Some ocean going vessels have fuels storage capacities of over 200,000 tons of fuel which requires several hours to take on a full supply of fuel. Bunker fuels are also called residual fuel oils, heavy fuel oils, navy special fuel oil or furnace fuels oil and its high viscosity or thickness requires it to be heated, usually by a reticulated low pressure steam system, before it can be pumped from a bunker tank or utilized by the engine.

In the past, in order to utilize these poor quality and low grade bunker fuels, the bunker fuels required the addition of a higher grade fuel oil, primarily diesel, to improve the quality of the bunker fuels and allow them to be used in the marine industry for an engine fuel, significantly adding cost to the bunker fuel. The addition of the higher grade fuel oils was also used to reduce pollution output and to reduce the potential damage to the engine within which it is being used as a fuel. Http://www.liquidminerals.com/fuels.htm.

A True Worth Index (TWI) has been introduced into the field of fuel oils and bunker fuel by Dr. R. Vis of the Viswa Lab Corporation which has been proposed for use in the bunker fuel industry along with a previously introduced index referred to as the Engine Friendliness Number (EFN). Http://www.binkerworld.com/quality/twi-index?month=02-07. The three most important properties of bunker fuel that determine the true worth to a marine engine are: Calorific Value (CV) with is the energy content of the fuel; CCAI, which indicates the ignition property of the fuel, but is better referenced as the Equivalent Cetane Number (ECN), which may actually be determined by use of an instrument to measure and determine the ignition and combustion properties (made by FUELTECH, Norway); and, the Engine Friendliness Number, supra., which provides information on the potential of the bunker fuel to cause wear and tear and increase maintenance expenses of the engine within which the bunker fuel is used. See also, http://www.viswalab.com/kb commonsense.htm.

Fuel oil and bunker fuel oils also vary depending upon the location where they are provided. Bunker fuels from the Middle East tend to have the highest TWI and the US has the worst, with the Middle East consistently having an ECN of 30 or above and the US having an ECN below 18.7, rendering the US bunker fuel oils unfit for use without adding a higher grade fuel oil to the bunker fuel in the US. The cost of bunker fuel is extremely low when compared to diesel fuel, the Middle East bunker fuels average cost of between $470 dollars per ton, over $700 per ton, with the US cost for the bunker fuel generally unfit for use at a cost of between $200 and $350 dollars per ton. http://www.binkerindex.com/prices/indices.php.

There are generally accepted four main industrial names for the four distinct fuel grades of bunker fuels based upon the viscosity of the bunker fuel. http://www.platts.com/IM.Platts.Content/.../shippingspecs.pdf. These four grades are IFO180, which indicates the viscosity of the fuel to be 180 cSt (centistokes) at 50 degrees Celsius, IFO 380, which indicates a viscosity of 380 cSt at 50 degrees Celsius, MDO or Marine Diesel Oil which is a blend of gas oil and heavy oil, and MGO, which is marine gas oil and is a clear liquid not blended with any heavy fuel. Of the above, the lowest grades of bunker fuels including sludge oil, unrefined oils or industrial waste oils are all types of bunker fuels and other low grade fuels otherwise classified as “not fit for use” having an ECN of less than 19.4, would be especially suited for the metal catalyst and method disclosed in this invention, elevating their respective ECN to a level classified as “fit for use” or preferred for use, reducing the potential damage to the engine and reducing the pollutant exhaust as a byproduct of the combustion. However, the catalyst and method also are suitable for elevating the combustibility of already good and acceptable fuel oils having higher ECN.

During testing of the method and catalyst mixture on low grade or heavy fuels and marine diesel oil categorized as unfit for use fuel sources using a FIA 100/3 instrument, some of the above disclosed indexes have been used to demonstrate the effectiveness of the catalyst mixture in improving the bunker fuels to a combustible or more efficient fuel source. It is therefore the primary objective of the invention to provide a catalyst mixture to convert low grade and low combustible bunker fuels to useable combustible fuel and to improve the combustion potential for low grade bunker fuels. A secondary objective is to have the catalyst mixture reduce the amount of exhaust pollutants during the combustion process. A third objective is to elevate the combustion potential of a higher grade fuel oil to achieve more efficient combustion and ignition potential while lowering pollutant output in the exhaust gasses.

Further distinction from Robinson '477, a prior art patent which used a different group of catalysts to improve the combustibility of higher grade fuels, such a gasoline and higher grade diesel fuel. Robinson '477 utilizes molybdenum within its claimed metal catalyst mixture, which specifically and intentionally uses the catalyst mixture defined as at least a Group 8B Platinum, plus one or more of a Group 8B Rhodium, Group 8B Rhenium, Group 3A Indium and/or Group 3A Aluminum by its explicit ratios as found in claims 2 and 4-6. Robinson requires a 6B Molybdenum (not anywhere found in the present catalyst mixture by direct or indirect reference and wrongfully suggested that the present claims are open ended enough to include molybdenum and also ruthenium, a fourth Group 8B compound having a different valence than Rhenium, Rhodium and Platinum.) In fact, Robinson requires at least all five of its catalysts, with Aluminum and Ruthenium being either substituted or both present. Robinson does not teach anything other than a complete and “substantially homogeneous mixture”.

Ruthenium negates the catalytic action of the other catalysts—Platinum, Rhenium and Rhodium. Although Ruthenium has been seen as somewhat useful catalyst in the dehydrogenation of five and six member hydrocarbon rings found in benzene and useful in its actions as a surface catalyst in industrial applications, it will inhibit the effectiveness of the other three catalysts by taking away essential hydrogen from the other catalytic metals and inhibit their functional abilities. Ruthenium is also much harder than the other metal catalysts and has a very high melting point, which would obviously distinguish it chemically from the other metal catalysts of the present claims, especially Indium, which is very soft and has a very low melting point.

Molybdenum and Ruthenium, catalysts not included in the present catalytic mixture, when used with Aluminum, have been shown in a cold environment, not a combustion environment, to absorb both hydrogen and oxygen in conducting electron flow in fuel cells, producing a desired endothermic reaction, not an exothermic reaction as is disclosed in the present claims for use in a combustion enhancing reaction. This combination is completely antithetical to the desired exothermic reaction found in the combustion of hydrocarbons. This process referred to as hydrogenation is confirmed by several studies ((Carbon-Supported, Selenium-Modified Ruthenium-Molybdenum Catalysts for Oxygen Reduction in Acidic Media, ChemSusChem, in press (DOI:10.1002/cssc.200800215 (2009) Jun. 24; 2(7): 658-664)) where Ruthenium in a high temperature environment in the presence of hydrocarbons will produce ammonia (NH3) which would deplete the amount of hydrogen available to complete the combustion reaction.

Robinson also teaches that Ruthenium and Aluminum are interchangeable, which is directly inconsistent with the present catalyst mixture disclosed and the chemical reactions contained within the present disclosure, taking Ruthenium and substituting it with Aluminum within its substantially homogeneous mixture with the other four required catalysts.

At no time does Robinson indicate that each of its catalysts may stand alone, as is consistent with the present catalyst mixture which may comprise a catalyst mixture of between one and five different metal catalysts, all having a distinct chemical property and effect on a combustion reaction. Robinson's only variance is the amount of each component and the interchangeablility of aluminum and Ruthenium, the reason for that substitution having no explanation within the specification or claims of Robinson.

In the present catalyst mixture, Indium is not a substitution for Aluminum. Each serves a different purpose. Robinson teaches that Indium is a substitute for Aluminum, but fails to provide a basis for the reason behind this generalized substitution. Although Indium and aluminum are in the same column of the periodic table, they are not the same, nor are they provided for the same purpose. Indium is very soft, malleable and easily fusible, which may bear some similarity to Aluminum. They have the same valence. However, it has been shown to be a distinctly different metal where it is added in very small amounts to an aluminum alloy sacrificial anodes for salt water applications to prevent passivation of the aluminum, which makes it obviously different than the aluminum alloy alone. It is also used instead of aluminum for applications as follows:
a. Indium oxide and indium tin oxide used as a transparent conductive coating applied to a glass substrate in the making of electroluminescent panels;
b. Indium compounds used as semiconductors, thin film solar cells, LEDs based on compound semiconductors such as InGaN, InGaP that are fabricated by Metalorganic Vapor Phase Epitaxy technology;
c. Indium's use to bond gold electrical test leads to superconductors as a conducting glue and applied under a microscope with precision tweezers, as a calibration material for Differential scanning calorimetry, in wire form as a vacuum seal in cryogenics and ultra-high vacuum applications, and as an ingredient substitute for the alloy Galinstan, which is liquid at room temperature but not toxic like mercury; and
d. Indium's high neutron capture cross section for thermal neutrons making it suitable for use in control rods for nuclear reactors, typically in an alloy containing 80% silver, 15% Indium and 5% Cadmium.
e. Indium would be a more obvious substitute for lead as opposed to molybdenum or ruthenium, as it is a conductor and melts at similar low end temperatures, as opposed to extremely high temperatures and is in fact used in some solutions for solder.

Indium is provided as an accelerant to improve the flow of electrons within the combustion process, whereas aluminum is provided to aid the catalytic action of the other catalysts and to accelerate the combustion process. Aluminum's function in the homogeneous stage is to enhance catalytic action and provide an alumina catalytic enhancing layer during the heterogeneous phase of the reaction, whereas indium is used specifically as an accelerant or combustion chamber conductor to improve the propagation of the flame front or transfer of electrons during combustion. Homogeneous as homogenized within the induction air not to be confused with homogeneous solution or combination.

The present catalyst mixture with its independently variable ratios, represents that any component can function and operate alone, while prior art teaches that all the metals must be contained within the substantially homogeneous mixture, or at least five out of six, with Aluminum and Ruthenium being interchangeable. The prior art is also not useful with low grade fuel oils, as is the present catalyst mixture.

### III. DESCRIPTION OF THE DRAWINGS

There are no drawings submitted with in this application.

### IV. DESCRIPTION OF THE PREFERRED EMBODIMENT

A metal catalyst mixture added to the combustion air of hydrocarbon fuel oils, heavy fuels and marine diesel oil to elevate the combustibility of the low grade fuel oils and to improve the combustibility of higher grade fuel oils, the metal catalyst mixture comprised of platinum, rhenium, rhodium, indium and aluminum. The presentation and injection of each of the metal catalyst is most effective delivered as a liquid or in a liquid suspension. Platinum, in the form of cloroplatinic acid, converts O₂ in the combustion chamber with the hydrocarbon fuel oil to O, resulting in improved combustion. Rhenium, provided in the form of perrhenic acid, gathers and converts random hydrocarbons, light ends or aromatics, into chained hydrocarbons resulting in a more efficiently burned hydrocarbon. Rhodium, provided in the form of rhodium chloride, is known to change the bonding temperature between nitrogen and oxygen in NOX. Indium, provided in the form of indium chloride, is known to contain and control electron transfer between molecules in the hydrocarbons during combustion. Aluminum, provided in the form of aluminum chloride, is known to accelerate any combustion in the hydrocarbon field and improve the effectiveness of the heterogeneous nano layer formed by the metals after combustion. This condition causes the effectiveness of this method to improve over time.

The introduction of each of the individual metal catalyst to the fuel oil must be independent so that the catalyst mixture may be varied by ratio depending on the hydrocarbon fuel oil to which the catalyst mixture is applied. The preferred ratio of the Pt—Re—Rh—In—Al catalyst mixture is 6.0:1.5:1.0:2.0:1.5, with rhodium being most varied dependant upon the hydrocarbon fuel oil, with each of the above individual metal catalyst components variable to ±4.0. Most preferably, the amount of catalyst mixture to hydrocarbon fuel is less than 80 parts per billion per weight of the hydrocarbon fuel.

Low grade hydrocarbon fuel oils, also known in the art as bunker fuels, are commonly used in the marine industry as fuel for large ocean going vessels. These include heavy fuel and marine diesel fuels, which will hereinafter be referenced as bunker fuels. Depending upon where the bunker fuels originate, the bunker fuels can vary from “unfit for use”, having a Equivalent Cetane Number (ECN) below 19.4 to a higher grade bunker fuel oil having an ECN of above 19.4. When the metal catalyst is added to bunker fuels having an ECN of less than 19.4 at the time of ignition, the ECN is elevated above 20, improving the ignition property of the bunker fuels. Even on bunker fuels having an ECN above 20, significant improvement can be demonstrated to the ignition properties by the addition of the metal catalyst mixture.

The independent introduction of each individual metal catalyst to the fuel oils is best achieved by injection into the ignition firing chamber of the engine, most often a slow speed 2-stroke engine or a 4-stroke medium speed engine. Each individual metal catalyst is presented as a liquid suspension mixed with air and is directed towards the fuel oil at the nearest location to the ignition point of the fuel oil. In an engine having a desiccant apparatus or a dehydrating apparatus, the injection of the metal catalyst would be directed after the desiccant or dehydrating apparatus in the engine to prevent condensation of the metal catalyst on the condensed water which typically gathers on the desiccant or dehydrating apparatus within the engine, diminishing the effective purpose and function of the metal catalyst and possibly altering the ratio of the metal catalyst mixture being injected into fuel oil and air mixture within the engine.

Each individual metal catalyst injection would be independently adjustable to provide an adjustment to the metal catalyst mixture depending on the subjective grade of the fuel oil being used as a fuel source. As previously indicated, the amount of rhodium in the metal catalyst mixture can very between 1.0 and 1.5, with more rhodium being added in inverse proportion to the ECN number of the bunker fuel to boost control of the NOX emissions. Where the ignition quality of the fuel oil is relatively low, more aluminum would be added. By making the injection of the individual metal catalyst independently adjustable, a more custom control of the efficiency of the combustibility of the fuel oil is obtained.

When fuel oils are use in the industry, the lower grade fuel oils generally require preheating of the fuel oil to at least an air temperature of 50° C. at an air pressure of 45 bar. In tests performed using a FIA 100/3 instrument according to the procedure established on the instrument when testing heavy fuels, several standards of measured results are obtained from the test instrument. “Ignition delay”, measured in milliseconds (ms) is defined as a time delay from the start of injection until an increase in pressure of 0.2 bar above the initial chamber pressure has been detected. “Start of Main Combustion” phase is determined as the time, in ms, when an increase in pressure 3 bars above the initial chamber pressure has been detected. “Start of Main Combustion” is used in order to establish the ignition quality of a fuel tested as a FIA CN (Cetane Number). The basis for FIA CN is a reference curve for the FIA 11/3 instrument being used to conduct the testing, showing the ignition properties for mixtures between reference fuels U15 and T22 from PHILLIPS PETROLEUM INTERNATIONAL®. This reference curve establishes the relation between ignition quality recorded in milliseconds and ECN for the different mixtures of the reference fuels. For heavy fuels, the ECN are typically in the range of 18.7 to above 40.

Base line fuels were tested prior to the addition of the metal catalyst mixture first with a “good fuel” having an ECN above 20 and second with a “bad fuel” having an ECN below 20. In the “good fuel” test, the good fuel tested alone without the metal catalyst mixture had an ECN of 39.9 with an ignition delay of 5.30 ms, a start of combustion time of 7.05 ms, and a combustion period of 15.7 ms. In a second test, the metal catalyst mixture was added to the “good fuel”, resulting in an ECN of 46.0, an ignition delay of 5.15 ms, a start of combustion time of 6.80 ms, and a combustion period of 14.9 ms. The ECN increased while the ignition delay decreased, the start of main combustion time decrease and the combustion period decreased.

In the “bad fuel” test, the bad fuel was tested alone resulting in an ECN below 19.4, an ignition delay of 8.90 ms, a start of main combustion of 12.05 ms, and a combustion period of 18.5 ms. After adding the metal catalyst mixture to the “bad fuel”, a first test resulted in an ECN of 21.5, an ignition delay of 7.90 ms, a start of main combustion of 10.90 ms, and a combustion period of 17.0 ms. A second test of the metal catalyst mixture and “bad fuel” resulted in an ECN of 23.6, an ignition delay of 7.65 ms, a start of main combustion of 10.30 ms, and a combustion period of 18.1. In both instances where the metal catalyst mixture was added to the “bad fuel”, the ECN increased, the ignition delay decrease, the start of main combustion decreased and the combustion period decreased. The conclusion of the testing demonstrates a significant improvement to both the “good fuel” and the “bad fuel” with regard to the quality of the fuel oil for use as an engine fuel.

A method for adapting an engine utilizing fuels oils to improve combustion of the fuel oil by injecting the metal catalyst mixture at the combustion point of the fuel oil within the engine would involve first installing within the engine five injectors with independent flow control devices, the five injectors directed towards a common injector target located at the point of combustion of the fuel oil within the engine with a first injector providing a controlled and regulated flow of a platinum metal catalyst, preferably in the form of chloroplatanic acid, to the combustion point of the fuel oil within the engine, a second injector providing a controlled and regulated flow of rhenium, preferably provided as perrhenic acid, to the combustion point of the fuel oil within the engine, a third injector providing a controlled and regulated flow of rhodium, preferably in the form of rhodium chloride, to the combustion point of the fuel oil within the engine, a fourth injector providing a controlled and regulated flow of indium, preferably in the form of indium chloride, to the combustion point of the fuel oil within the engine and a fifth injector providing a controlled and regulated flow of aluminum, preferably in the form of aluminum chloride, to the combustion point of the fuel oil, the platinum, rhenium, rhodium, indium and aluminum being contemporaneously injected at a relative ratio of 6.0:1.5:1.0;:2.0:1.5 variable to ±4.0, with a combined mixture to fuel oil of less than 80 parts per billion per weight of the fuel oil. The fuel oil and engine combustion components would be otherwise be unaffected, other than by noted improvement to the combustibility of the fuel oil within the engine and enhanced engine power production and efficiency.

Alternatively, the method for adapting an engine utilizing fuels oils to improve the combustion of the fuel oil by injecting the metal catalyst mixture at the combustion point of the fuel oil within the engine would comprise the steps of installing a single injector within the engine directed at the combustion point, attaching a pre-mixture manifold to the injector, attaching a first injector line having an independent flow control device to the manifold, attaching a second injector line having an independent flow control device to the manifold, attaching a third injector line having an independent flow control device to the manifold, attaching a fourth injector line having an independent flow control device to the manifold, attaching a fifth injector line having an independent flow control device to the manifold, directing a flow of platinum metal catalyst, preferably in the form of chloroplatanic acid, to the first injector line, directing a flow of rhenium metal catalyst, preferably in the form of perrhenic acid, to the second injector line, directing a flow of rhodium metal catalyst, preferably in the form of rhodium chloride, to the third injector line, directing a flow of indium metal catalyst, preferably in the form of indium chloride, to the fourth injector line, directing a flow of aluminum metal catalyst, preferably in the form of aluminum chloride, to the fifth injector line, mixing the platinum metal catalyst, rhenium metal catalyst, rhodium metal catalyst, indium metal catalyst and aluminum metal catalyst in a preferred ratio of 6.0:1.5:1.0:2.0: 1.5 variable to ±4.0, with a combined catalyst mixture to fuel oil of less than 80 parts per billion per weight of fuel oil. The fuel oil and engine combustion components would be otherwise be unaffected, other than by noted improvement to the combustibility of the fuel oil within the engine and enhanced engine power production and efficiency.

While the invention has been particularly shown and described with reference to a preferred embodiment thereof, it will be understood by those skilled in the art that changes in form and detail may be made therein without departing from the spirit and scope of the invention.

What is claimed is:

1. A metal catalyst mixture added to the combustion air of hydrocarbon fuel oils within a combustion chamber, including bunker fuels and marine diesel oil, to elevate combustibility of the low grade fuel oils and to improve the combustion of higher grade fuel oils, said metal catalyst mixture comprising platinum, rhodium, rhenium, indium and aluminum, said Platinum converting O₂ in said hydrocarbon fuel oil within said combustion chamber to O for improved combustibility, said Rhenium gathering and converting random hydrocarbons and light end aromatics into chained hydrocarbons to enhance combustion efficiency, said Rhodium changing the bonding temperature between nitrogen and oxygen to boost control of NOX in an exhaust gas and improve combustibility, said indium containing and controlling electron transfer within said hydrocarbon fuel oils enhance said combustibility efficiency, and said Aluminum to accelerate said combustion and to enhance effectiveness of other said metal catalysts within said combustion chamber.

2. The metal catalyst mixture, as disclosed in claim 1, wherein a respective ratio of said platinum, rhenium, rhodium, indium and aluminum within said metal catalyst mixture is a variable having a base ratio of 6.0:1.5:1.0:2.0:1.5, with said metal catalyst mixture to hydrocarbon fuel oil at less than 80 parts per billion per weight of said fuel oil.

3. The metal catalyst mixture, as disclosed in claim 1, wherein a respective ratio of said platinum, rhenium, rhodium, indium and aluminum within said metal catalyst mixture is 6.0:1.5:1.0:2.0:1.5, variable to ±4.0, with said metal catalyst mixture to hydrocarbon fuel oil at less than 80 parts per billion per weight of said fuel oil.

4. The metal catalyst mixture, as disclosed in claim 1, wherein said platinum is presented as chloroplatanic acid, said rhenium is presented as perrhenic acid, said rhodium is presented as rhodium chloride, said indium is presented as indium chloride and said aluminum is presented as aluminum chloride.

5. The metal catalyst mixture, as disclosed in claim 1, wherein said platinum is presented as chloroplatanic acid, said rhenium is presented as perrhenic acid, said rhodium is presented as rhodium chloride, said indium is presented as indium chloride and said aluminum is presented as aluminum chloride; and
a respective ratio of the platinum, rhenium, rhodium, indium and aluminum within said metal catalyst mixture is a variable having a base ratio of 6.0:1.5:1.0:2.0:1.5, with said metal catalyst mixture to hydrocarbon fuel oil at less than 80 parts per billion per weight of said fuel oil.

6. The metal catalyst mixture, as disclosed in claim 1, wherein said platinum is presented as chloroplatanic acid, said rhenium is presented as perrhenic acid, said rhodium is presented as rhodium chloride, said indium is presented as indium chloride and said aluminum is presented as aluminum chloride; and
a respective ratio of the platinum, rhenium, rhodium, indium and aluminum within said metal catalyst mixture is 6.0:1.5:1.0:2.0:1.5, variable to ±4.0, with said metal catalyst mixture to said hydrocarbon fuel oil at less than 80 parts per billion per weight of said fuel oil.

7. The metal catalyst mixture, as disclosed in claim 1, wherein each said metal catalyst is independently injected as a liquid suspension mixed with air into said fuel oil at an ignition point of said fuel oil within an ignition firing chamber of an engine utilizing said fuel oil, said platinum is presented as chloroplatanic acid, said rhenium is presented as perrhenic acid, said rhodium is presented as rhodium chloride, said indium is presented as indium chloride and said aluminum is presented as aluminum chloride; and
a respective ratio of the platinum, rhenium, rhodium, indium and aluminum within said metal catalyst mixture is a variable having a base ratio of 6.0:1.5:1.0:2.0:1.5, with said metal catalyst mixture to hydrocarbon fuel oil at less than 80 parts per billion per weight of said fuel oil.

8. The metal catalyst mixture, as disclosed in claim 1, wherein each said metal catalyst is independently injected as a liquid suspension mixed with air into said fuel oil at an ignition point of said fuel oil within an ignition firing chamber of an engine utilizing said fuel oil, said platinum is presented as chloroplatanic acid, said rhenium is presented as perrhenic acid, said rhodium is presented as rhodium chloride, said indium is presented as indium chloride and said aluminum is presented as aluminum chloride; and
a respective ratio of the platinum, rhenium, rhodium, indium and aluminum within said metal catalyst mixture is 6.0:1.5:1.0:2.0:1.5, adjustably variable to ±4.0, with said metal catalyst mixture to said fuel oil at less than 80 parts per billion per weight of said fuel oil, said ratio being variably adjustable dependant upon the quality of said fuel oil.

9. The metal catalyst mixture, as disclosed in claim 1, wherein each said metal catalyst is a uniformly mixed liquid suspension combined with air injected into said fuel oil at an ignition point of said fuel oil within an ignition firing chamber of an engine utilizing said fuel oil, said platinum is presented as chloroplatanic acid, said rhenium is presented as perrhenic acid, said rhodium is presented as rhodium chloride, said indium is presented as indium chloride and said aluminum is presented as aluminum chloride; and
a respective ratio of the platinum, rhenium, rhodium, indium and aluminum within said metal catalyst mixture is variable having a base ratio of 6:0:1.5:1.0:2.0:1.5, with said metal catalyst mixture to hydrocarbon fuel oil at less than 80 parts per billion per weight of said fuel oil.

10. The metal catalyst mixture, as disclosed in claim 1, wherein each said metal catalyst is a uniformly mixed liquid suspension combined with air injected into said fuel oil at an ignition point of said fuel oil within an ignition firing chamber of an engine utilizing said fuel oil, said platinum is presented as chloroplatanic acid, said rhenium is presented as perrhenic acid, said rhodium is presented as rhodium chloride, said indium is presented as indium chloride and said aluminum is presented as aluminum chloride; and
a respective ratio of the platinum, rhenium, rhodium, indium and aluminum within said metal catalyst mixture is 6.0:1.5:1.0:2.0:1.5, adjustably variable to ±4.0, with said metal catalyst mixture to said fuel oil at less than 80 parts per billion per weight of said fuel oil, said ratio being variably adjustable dependant upon the quality of said fuel oil.
